(19) United States
(12) Patent Application Publication
(10) Pub. No.: US 2026/0088214 A1
(43) Pub. Date: Mar. 26, 2026

(54) EMI FILTER

(71) Applicant: MAHLE International GmbH, Stuttgart (DE)

(72) Inventors: Kristjan Saksida, Dornberk (SI); Marko Jankovec, Polhov Gradec (SI); Gregor Ergaver, Dobravlje (SI)

(21) Appl. No.: 19/339,237

(22) Filed: Sep. 24, 2025

(30) Foreign Application Priority Data
Sep. 25, 2024 (DE) 102024127825.0

(51) Int. Cl. H01F 27/34; H02K 11/02; H02M 1/44

(52) U.S. Cl. CPC H01F 27/34; H02K 11/02; H02M 1/44

(57) ABSTRACT

An EMI filter is disclosed. The EMI filter includes a core forming a closed magnetic circuit, the core having a first core pillar, a second core pillar and a third core pillar. The second core pillar is arranged between the first core pillar and the third core pillar. The ends of the core pillars are connected by first and second bridging legs. A first coil is arranged around the first core pillar and/or the first bridging legs. A second coil is arranged around the third core pillar and/or the second bridging legs. A compensation winding is arranged on the core and includes a first compensation coil and a second compensation coil, for inducing a magnetic flux density in the second core pillar by direct current supplied through the first coil and through the second coil, for reducing a resulting magnetic flux in the second core pillar.

### CROSS-REFERENCE TO RELATED APPLICATIONS

This application claims priority to German Patent Application No. DE 102024127825.0, filed on Sep. 25, 2024, the contents of which is hereby incorporated by reference in its entirety.

### TECHNICAL FIELD

The present invention relates generally to electromagnetic interference (EMI) filters and EMI filter circuits and a process for filtering EMI interference.

### BACKGROUND

CN115938747 discloses an EMI filter for use in a filter circuit of an electric compressor controller. The EMI filter has a core formed of two E-shaped core parts arranged in an opposing configuration. The core thus has two parallel pillars joined at the top and bottom by bridging parts. The core is provided with two winding coils for supplying current to and from a compressor motor, the winding coils being arranged on the two pillars. In order to suppress differential mode (DM) interference it is known to have a middle pillar arranged between the two outer pillars, so that magnetic flux generated by DM interference in the two winding coils can use a common path through the middle pillar. This however leads to a saturation of the middle pillar when there are DM currents. In the embodiment shown in CN115938747 a gap is introduced into the middle pillar. This gap reduces the susceptibility to saturation of the magnetic core material.

The object of the present invention is to provide an improved or alternative EMI filter circuit and method of filtering electromagnetic interference (EMI) in a circuit.

### SUMMARY

This is achieved in a first aspect of the invention by providing an EMI filter with a filter core having a compensation winding.

The core forms a closed magnetic circuit, and having a first core pillar, a second core pillar and a third core pillar extending in a parallel direction, wherein the second core pillar is arranged between the first core pillar and the third core pillar. The ends of the first core pillar and the second core pillar are connected by first bridging legs, and the ends of the second core pillar and the third core pillar are connected by second bridging legs. The first core pillar, the second core pillar and the first bridging legs delimit a first opening, and, the second core pillar, the third core pillar and the second bridging legs delimit a second opening.

A first coil is arranged around the first core pillar and/or the first bridging legs, the first coil is part of a first DC power line conductor for connection to a DC power source and a load. A second coil is arranged around the third core pillar and/or the second bridging legs, the second coil is part of a second DC power line conductor for connection to a DC power source and a load. The EMI filter further comprises a compensation winding for connection to a power supply, and a compensation current controller for controlling the current supply to the compensation winding. The compensation winding is arranged on the core and comprises a first compensation coil and a second compensation coil, the first compensation coil is arranged around the first core pillar and/or the first bridging legs, and the second compensation coil is arranged around the third core pillar and/or the second bridging legs, for inducing a magnetic flux density in the second core pillar in a direction opposing the direction of a magnetic flux density generated in the second core pillar by direct current supplied through the first coil and through the second coil, for reducing a resulting magnetic flux in the second core pillar.

DC power lines may be subject to direct mode interference, which is noise or unwanted signals carried on the two power lines but in opposite directions. This noise can arise for example when using high frequency switching devices in the power circuit, as is the case when using a motor inverter. The first coil on the EMI filter core, being part of a DC power line, forms an inductor for suppressing the DM interference. Similarly, the second coil on the EMI filter core, being part of a DC power line, forms an inductor for suppressing the DM interference.

The first coil and the second coil are wound around the core such that the DC current, i.e. the current to and from the DC power supply, flows through the respective first opening and second opening in opposite directions. Differential mode noise therefore induces a magnetic flux in the core in opposite circumferential directions around the first opening and the second opening respectively. This magnetic flux sums up in the second core pillar, such that the second core pillar is susceptible to saturation from high DC current values in the first and second DC power line conductors. It would be possible to introduce a gap into the second pillar of the core to reduce the magnetic flux density and susceptibility to saturation, however this would also decrease the inductance properties of the core. Instead of having an air gap, it is proposed to use a compensation winding arranged on the core for inducing a magnetic flux density in the second core pillar in a direction opposing the direction of a magnetic flux density generated in the second core pillar by direct current supplied through the first coil and the second coil. The resulting magnetic flux in the second core pillar is therefore reduced so that it is less susceptible to magnetic saturation. This approach ensures maximal DM inductance value of the core regardless of the DC current value flowing through the core.

Furthermore, in the configuration according to the invention the EMI filter can suppress both common mode and differential mode interference, whereby common mode interference, which occurs when noise appears in phase in both power lines, generates a magnetic flux which is summed up in the core. The common mode noise generates a magnetic flux flow in a circuit around the outside of the core in the first core pillar and the third core pillar and the bridging legs. The energy from the common mode interference is therefore stored in the core such that the noise in the power lines is attenuated and noise does not propagate further through the circuit. The core and the coils therefore have an inductive impedance attenuating common mode noise which is not affected by DC current value.

The core is preferably gapless, which means it forms a closed magnetic circuit without any air gaps. The core preferably has uniform magnetic permeability, or is made out of material with uniform magnetic permeability. By making the core gapless the inductance properties of the core are not reduced.

The core can comprises of two or more core parts. These parts can be connected together in a gapless manner to form a closed magnetic circuit. In a preferred embodiment the core is an EE-core. Other configurations can however also be used to form the core with three pillars, for example an EI or TU type core. The cross sections of the second core pillar can be rectangular or circular.

In the preferred embodiment the first coil is connected at one end to a first terminal of a DC power source. Similarly, the second coil is connected at one end to a second terminal of the DC power source.

The first coil and the second coil are arranged in a power circuit before and after a load respectively.

In a preferred embodiment the first compensation coil and the second compensation coil are connected in series, the first compensation coil is arranged around the first pillar or one of the first bridging legs. The second compensation coil is arranged around the third pillar or one of the second bridging legs. This prevents core saturation for CM signals in a circuit around the outside of the core. The first compensation coil and the second compensation coil 26 are connected in series and are wound in opposite directions such that the flow of magnetic flux is directed in opposite circumferential directions around the outside of the core and in the same direction through the second core pillar. In an alternative embodiment the coils can be connected in parallel.

The compensation current controller comprises an open loop compensation algorithm, which can provide a compensation current in the compensation winding dependent on a DC current in the first coil and/or the second coil. Alternatively, the compensation current can be made dependent on at least two of the phase currents of an inverter or electric motor. For example, at least two of the phase currents, preferably all the phase currents, can be provided as an input to the compensation current controller. The current in the DC power line could be also measured.

The first coil, as part of the DC power line comprises a plurality of turns of a conductor having a rectangular cross section. Similarly the second coil can comprises a plurality of turns of a conductor having a rectangular cross section.

The EMI filter can advantageously be part of a motor drive.

The motor drive comprises a circuit wherein the first coil is connected to a DC power source and is arranged in the circuit upstream of a load, in particular the motor, and the second coil is connected to the DC power source and arranged in the circuit downstream of the load, wherein the compensation winding forms part of a compensation circuit comprising a compensation current controller for supplying current to the compensation winding. A DC power supply, or current source is connected to the the compensation winding.

The DC power line conductor is connected to the input of a motor inverter, which is configured to convert a DC input into three or more AC phases for driving an electric motor.

As mentioned above, the compensation current controller comprises an open loop compensation algorithm, which can provide a compensation current in the compensation winding dependent on at least two phase currents, preferably all phase currents, of the AC phases of the inverter. Alternatively, the measured current in at least two of the phases may be used as an input for estimating the current in the DC power line and/or as an input for controlling the current in the compensation winding.

In a preferred embodiment the DC power source is configured to supply a voltage of at least 48 V across the first DC power line conductor leading away from the DC power source and the second DC power line conductor leading to the DC power source.

In a second aspect of the invention a method for filtering electromagnetic interference (EMI) in a power circuit is provided. The method comprising:
providing a core forming a closed magnetic circuit, the core having a first core pillar, a second core pillar and a third core pillar extending in a parallel direction, wherein the second core pillar is arranged between the first core pillar and the third core pillar,
the ends of the first core pillar and the second core pillar are connected by first bridging legs, and the ends of the second core pillar and the third core pillar are connected by second bridging legs,
the first core pillar, the second core pillar and the first bridging legs delimiting a first opening, and,
the second core pillar, the third core pillar and the second bridging legs delimiting a second opening,
providing a first coil around the first core pillar and/or the first or bridging legs, the first coil is part of a first DC power line conductor for connection to a DC power source and a load,
providing a second coil around the third core pillar and/or the second bridging legs, the second coil is part of a second DC power line conductor for connection to a DC power source and a load,
providing a compensation circuit comprising a compensation winding, the compensation winding is arranged on the core and comprises a first compensation coil and a second compensation coil, the first compensation coil is arranged around the first core pillar and/or the first bridging legs, and the second compensation coil is arranged around the third core pillar and/or the second bridging legs,
controlling a compensation current in the compensation winding, so that a magnetic flux density in the second core pillar is generated in a direction opposing a magnetic flux density generated by the first coil and by the second coil in the second core pillar.

Any features disclosed as being part of the first aspect of the invention can be in the second aspect of the invention, either alone or in combination, or follow any arrangement or permutation of any one or more of the described elements.

### BRIEF DESCRIPTION OF THE DRAWINGS

Embodiments will now be described by way of example only with reference to the accompanying drawings, in which:

FIG. 1 shows a schematic drawing of an EMI filter according to the invention;

FIG. 2 shows a schematic drawing of an EMI filter according to the invention in a motor drive;

FIG. 3 shows a perspective view of part of an EMI filter according to one embodiment of the invention;

FIG. 4 shows an exploded view of part of an EMI filter according to one embodiment of the invention;

FIG. 5 shows a schematic drawing of the an EMI filter according to one embodiment of the invention; and

FIG. 6 shows a table.

### DETAILED DESCRIPTION

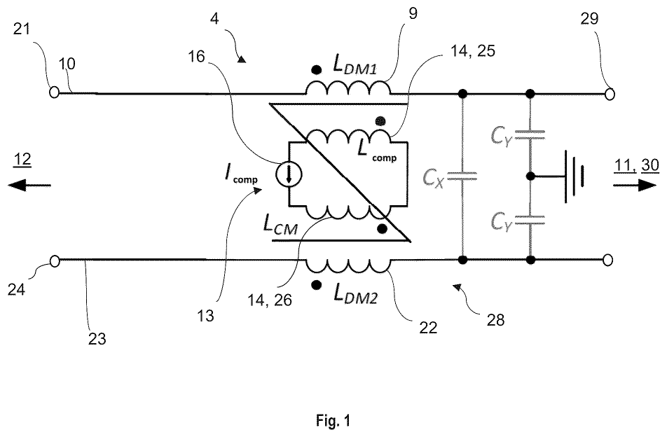

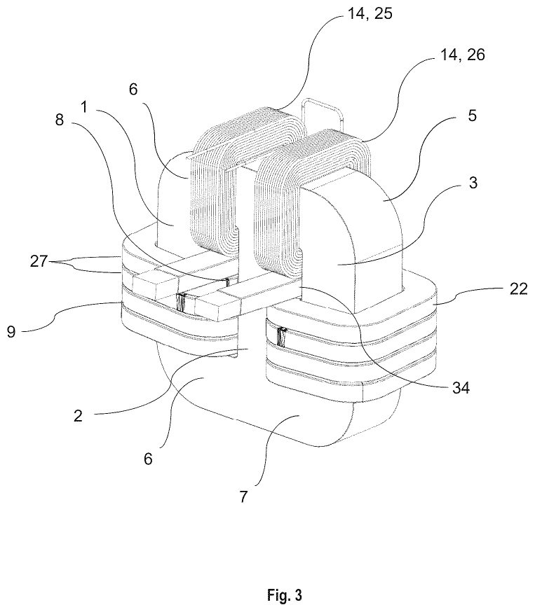

FIG. 1 shows a schematic drawing of an EMI filter 4 according to the invention. The EMI filter 4 comprises a first coil 9 which forms a first inductor LDM1 and a second coil 22 which forms a second inductor LDM2. The first coil 9 and the second coil 22 are provided on a core 5 as shown in FIG. 3. The core 5 forms a closed magnetic circuit, and has a first core pillar 1, a second core pillar 2 and a third core pillar 3 extending in a parallel direction. The second core pillar 2 is arranged between the first core pillar 1 and the third core pillar 3. The ends of the first core pillar 1 and the second core pillar 2 are connected by first bridging legs 6, and the ends of the second core pillar 2 and the third core 3 pillar are connected by second bridging legs 7. The first core pillar 1, the second core pillar 2 and the first bridging legs 6 delimit a first opening 8, whilst the second core pillar 2, the third core pillar 3 and the second bridging legs 7 delimit a second opening 34.

The first coil 9 is arranged around the first core pillar 1. The first coil 9 can however be provided in other configurations, for example around the first bridging legs 6, meaning around one of the bridging legs 6 at the top or the bottom of the core in FIG. 3, or partly on the bridging legs 6 and partly on the first core pillar 1. The first coil 9 is part of a DC power line conductor 10 connected to a DC power source 12 via a first terminal 21 and is also connected to a load 11. The second coil 22 is arranged around the third core pillar 3. The second coil 22 can however also be provided in other configurations, for example around the second bridging legs 7, or partly on the bridging legs 7 and partly on the third core pillar 3. The second coil 22 is part of a return DC power line conductor 23 connected to a load 11 and to the DC power source 12 via a second terminal 24. The DC power source 12 can be a battery or the output of an AC/DC converter. The first coil 9 and the second coil 22 are thus arranged in the power circuit before and after the load 11 respectively.

The EMI filter 4 further comprises an across-the-line capacitor CX connected to the first power line conductor 10 and the second power line conductor 23 for suppressing differential mode noise, and two line bypass capacitors CY connected between the first and second power line conductors 10, 23 and a ground respectively for suppressing common mode noise. The capacitors provide a low impedance path for noise to pass through the capacitor instead of continuing along the power line.

The EMI filter 4 further comprises a compensation winding 14 connected to a power supply 15, and a compensation current controller 16 for controlling the current supply to the compensation winding 14.

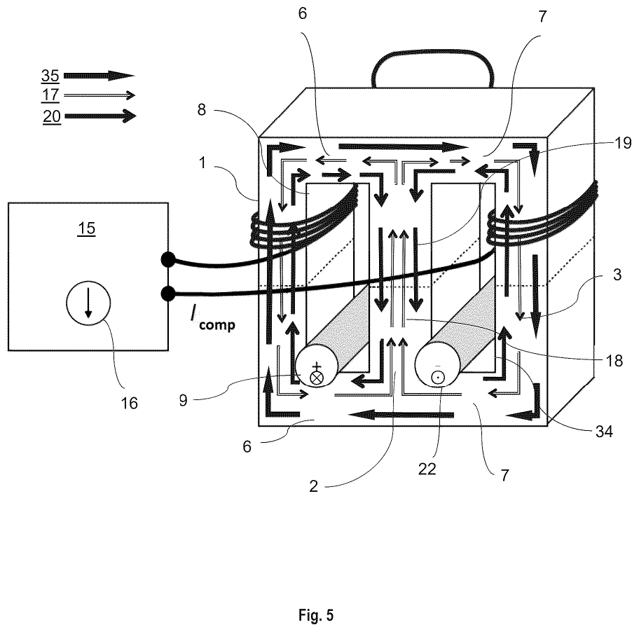

In the embodiment shown in FIG. 3, the compensation winding 14 is arranged on the core 5 around the first bridging legs 6 and the second bridging legs 7, however again other configurations are possible. In the embodiment in FIG. 5 the compensation winding 14 is provided on the first core pillar 1 and the third core pillar 3.

The compensation winding 14 is arranged for inducing a magnetic flux density in the second core pillar 2 in a direction opposing the direction of a magnetic flux density induced in the second core pillar 2 by direct current supplied through the first coil 9 and second coil 22. This enables the resulting magnetic flux in the second core pillar 2 to be reduced so that the second core pillar 2 is less susceptible to magnetic saturation. This is illustrated schematically in FIG. 5. The first coil 9 is arranged such that current flows through a conductor through the first opening 8 in a first current direction indicated with a ⊗ and the second coil 22 is arranged such that current flows through a conductor through the second opening 24 in a second current direction, opposite to the first direction, indicated with a ⊙. The first coil 9 and the second coil 22 are arranged in a circuit which may be subject to common mode noise and differential mode noise. Common mode noise is conducted in the conductors 10, 23 through the first opening 8 and the second opening 34 in the same direction. As a result of the common mode noise, magnetic flux flows through the core 5 as indicated with the common mode arrows 35. The magnetic flux flows in a circuit around the outside of the core 5 in the first core pillar 1 and the third core pillar 3 and the bridging legs 6, 7. The energy from the common mode interference is therefore stored in the core 5 such that the noise in the power lines is attenuated and noise does not propagate further through the power circuit 28. The core 5 and the coils 9, 22 therefore have an inductive impedance attenuating common mode noise, which is not affected by DC current value

DC power lines may also be subject to direct mode interference, which is noise or unwanted signals carried on the two power lines 10, 23 but in opposite directions. This noise can arise for example when using high frequency switching devices in the power circuit, as is the case when using a motor inverter.

The first coil 9 on the EMI filter core 5, is part of the DC power line 10, and forms an inductor for suppressing the DM noise. Similarly the second coil 22 on the EMI filter core 5, is part of the return DC power line 23, and forms an inductor for suppressing the DM noise. The same core 5 can therefore be used for both common mode and differential mode noise attenuation.

The direction of the magnetic flux generated in the core by the first coil 9 and the second coil as a result of the DC current supplying the load 11 is indicated by the arrows 20. The direction of the magnetic flux generated by the first coil 9 and the second coil 22 as a result of DM noise may also by in the same direction as indicated by the arrows 20. It can be seen in FIG. 5, that the magnetic flux generated by the DM noise in the first coil 9 and the second coil 22 sums up in the second core pillar 2. This DM noise can lead to an undesired magnetic saturation of the second pillar 2.

To counter this, the compensation winding 14 is provided in this embodiment by a first compensation coil 25 arranged on the first pillar 1 and a second compensation coil 26 arranged on the third pillar 3, however again other configurations for the compensation winding are possible. In the embodiments shown in FIGS. 3 to 5, the first compensation coil 25 and a second compensation coil 26 are connected in series and are wound in opposite directions such that the flow of magnetic flux is directed in opposite circumferential directions around the outside of the core 5 and in the same direction through the second core pillar 2. The use of two coils 25, 26 connected in series prevents core saturation for CM signals in a circuit around the outside of the core.

The compensation winding 14 is connected to a compensation current controller 16 and a power supply 15, providing a DC current to the compensation winding 14. It can be seen from FIG. 5 that the compensation winding 14 generates a magnetic flux, indicated by arrows 17, in a direction opposite to the magnetic flux 19 generated by the DC current supplying the load 11. By providing the core 5 with a compensation winding 14, arranged to counteract the magnetic flux density generated by the direct current in the power line coil 9, the second core pillar 2 avoids becoming magnetically saturated. This approach ensures maximal DM inductance value of the core regardless of the DC current value flowing through the core 5.

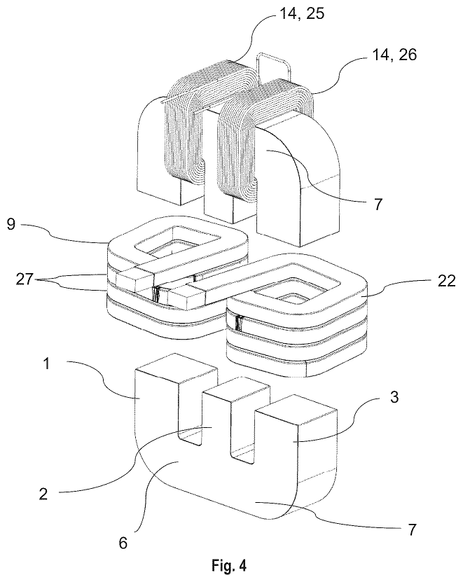

In the embodiments shown in the figures the core 5 is gapless, which means it forms a closed magnetic circuit without any air gaps. The core is formed of a magnetic material, preferably a ferrite, iron powder or an amorphous metal. By making the core gapless the inductance properties of the core 5 are not reduced. Referring now to FIG. 4, which shows an exploded view of the EMI filter core 5, the core 5 is made up of two core parts forming an EE-type core, as both of parts have an E-shape. These parts can be connected together in a gapless manner to form a closed magnetic circuit. Other configurations can however also be used to form the core with three pillars, for example an EI- or TU-type core. The cross sections of the first core pillar 1, the second core pillar 2 and the third core pillar 3 are rectangular in the embodiment show, however other cross sections, e.g. circular can be provided. The first core pillar 1 and the third core pillar 3 can also be curved, merging with the respective bridging legs 6, 7 to form a D-shape with the second core pillar.

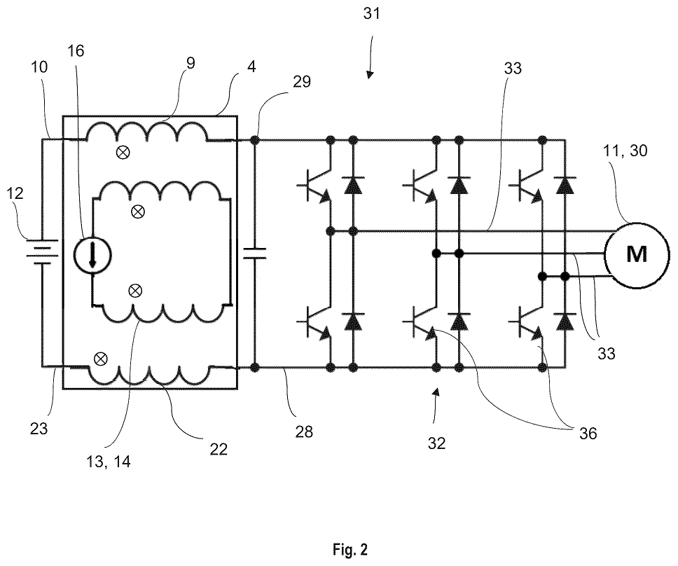

The EMI filter 4 can be, by way of example, part of a motor drive 31 comprising a drive circuit 28 wherein the first coil 9 is connected to a DC power source 12 and is arranged in the circuit 28 upstream of a motor 30, as illustrated schematically in FIG. 2. The second coil 22 is connected to the DC power source 12 and is arranged in the circuit downstream of the motor 30. The compensation winding 14 forms part of a compensation circuit 13 comprising a compensation current controller 16 for supplying current to the compensation winding 14. A DC power source (not shown) is connected to the the compensation winding 14. The DC power line conductor 10 is connected to the input 29 of a motor inverter 32, which is configured to convert a DC input into three AC phases 33 with switching devices 36, e.g. MOSFETs, for driving the electric motor 30. In other embodiments more than three phases can be used.

The compensation current controller 16 comprises an open loop compensation algorithm, which can provide a compensation current in the compensation winding 14 dependent on a DC current in the first coil 9 or the second coil 22. Alternatively, the compensation current in the compensation winding 14 can be made dependent on phase currents of the AC phases 33 of the inverter 32. Alternatively, the measured current in at least two of the phases 33 may be used as an input for estimating the current in the DC power line 10 and/or as an input for controlling the current in the compensation winding 14. In each case appropriate current sensors are provided. The current in the DC power line could be also measured.

The DC power source 12 is configured to supply a voltage of at least 48 V across the DC power line conductor 10 leading away from the DC power source and the DC power line conductor 23 leading to the DC power source. The first coil 9, as part of the DC power line 10 comprises a plurality of turns 27 of a conductor having a rectangular cross section. Similarly the second coil 22 can comprises a plurality of turns 27 of a conductor having a rectangular cross section. The number of turns is preferably between one and ten turns 27, so that the cross section of the coil conductor, in the space provided, can carry sufficient current for high power applications. A larger number of turns can be provided for the compensation winding 14 where the compensation winding conductor carries a lower current.

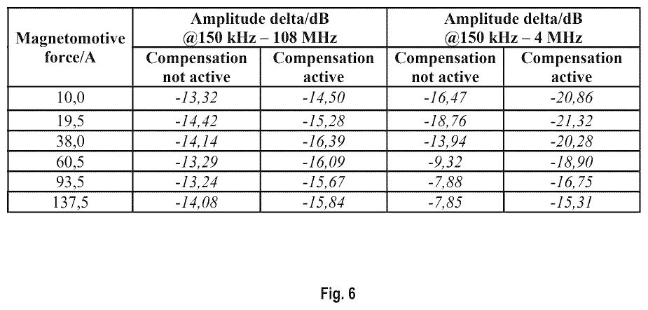

FIG. 6 is a table showing the reduction in the EMI noise for different DC currents through the core 5. The magnetomotive force is a measure of the current in the first coil passing through the core and is dependent of the number of turns. It can be seen that when the compensation is active, i.e. when a controlled current is supplied through the compensation winding 14, there is a significant reduction in the amplitude of the noise that can be transmitted through the power line conductor 10.

The invention also provides a method for filtering electromagnetic interference (EMI) in a power circuit. The method comprising providing such an EMI filter 4 and controlling a compensation current in the compensation winding 14, so that a magnetic flux density in the second core pillar 2 is generated in a direction opposing a magnetic flux density generated by the first coil 9 and by the second coil 22 in the second core pillar 2.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining”or “in response to detecting,”depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context.

All matter contained in the above description or shown in the accompanying drawings shall be interpreted as illustrative only and not limiting. Changes in detail or structure may be made without departing from the present disclosure.

1. An EMI filter, comprising:
a core forming a closed magnetic circuit, the core having a first core pillar, a second core pillar and a third core pillar extending in a parallel direction, wherein the second core pillar is arranged between the first core pillar and the third core pillar,
ends of the first core pillar and the second core pillar connected by first bridging legs, and ends of the second core pillar and the third core pillar connected by second bridging legs,
the first core pillar, the second core pillar and the first bridging legs delimiting a first opening,
the second core pillar, the third core pillar and the second bridging legs delimiting a second opening,
a first coil arranged around the first core pillar and/or the first bridging legs, the first coil is part of a first DC power line conductor for connection to a DC power source and a load,
a second coil arranged around the third core pillar and/or the second bridging legs, the second coil is part of a second DC power line conductor for connection to a DC power source and a load,
a compensation winding for connection to a power supply, and a compensation current controller for controlling the current supply to the compensation winding,
the compensation winding is arranged on the core and comprises a first compensation coil and a second compensation coil, the first compensation coil is arranged around the first core pillar and/or the first bridging legs, and the second compensation coil is arranged around the third core pillar and/or the second bridging legs, for inducing a magnetic flux density in the second core pillar in a direction opposing a direction of a magnetic flux density generated in the second core pillar by direct current supplied through the first coil and through the second coil, for reducing a resulting magnetic flux in the second core pillar.

2. The EMI filter according to claim 1, wherein the core is gapless, and forms a closed magnetic circuit out of material with uniform magnetic permeability.

3. The EMI filter according to claim 1, wherein the first coil is connected at one end to a first terminal of a DC power source, and the second coil is connected at one end to a second terminal of the DC power source.

4. The EMI filter according to claim 1, wherein the first compensation coil and the second compensation coil are connected in series.

5. The EMI filter according to claim 1, wherein the first compensation coil and the second compensation coil are connected in parallel.

6. The EMI filter according to claim 1, wherein the first coil comprises a plurality of turns of a conductor having a rectangular cross section.

7. The EMI filter according to claim 1, wherein the compensation current controller comprises an open loop compensation algorithm, which provides a compensation current in the compensation winding dependent on a DC current in the first coil and/or the second coil.

8. The EMI filter according to claim 1, wherein the core comprises of two or more core parts.

9. A motor drive, comprising: a circuit with an EMI filter, the EMI filter including:
a core forming a closed magnetic circuit, the core having a first core pillar, a second core pillar and a third core pillar extending in a parallel direction, wherein the second core pillar is arranged between the first core pillar and the third core pillar,
the first core pillar and the second core pillar having ends connected by first bridging legs, and the second core pillar and the third core pillar having ends connected by second bridging legs,
the first core pillar, the second core pillar and the first bridging legs delimiting a first opening,
the second core pillar, the third core pillar and the second bridging legs delimiting a second opening,
a first coil arranged around the first core pillar and/or the first bridging legs, the first coil is part of a first DC power line conductor for connection to a DC power source and a load,
a second coil arranged around the third core pillar and/or the second bridging legs, the second coil is part of a second DC power line conductor for connection to a DC power source and a load,
a compensation winding for connection to a power supply, and a compensation current controller for controlling the current supply to the compensation winding,
the compensation winding is arranged on the core and comprises a first compensation coil and a second compensation coil, the first compensation coil is arranged around the first core pillar and/or the first bridging legs, and the second compensation coil is arranged around the third core pillar and/or the second bridging legs, for inducing a magnetic flux density in the second core pillar in a direction opposing a direction of a magnetic flux density generated in the second core pillar by direct current supplied through the first coil and through the second coil, for reducing a resulting magnetic flux in the second core pillar.

10. The motor drive according to claim 9, comprising a circuit, wherein the first coil is connected to a DC power source and is arranged in the circuit upstream of the load, and the second coil is connected to the DC power source and arranged in the circuit downstream of the load, wherein the compensation winding forms part of a compensation circuit comprising the compensation current controller for supplying current to the compensation winding.

11. The motor drive according to claim 9, wherein the first DC power line conductor is connected to the input of a motor inverter, which is configured to convert a DC input into three or more AC phases for driving an electric motor.

12. The motor drive according to claim 9, wherein the compensation current controller comprises an open loop compensation algorithm, which provides a compensation current in the compensation winding dependent on a phase current in at least two AC phases of a motor inverter.

13. The motor drive according to claim 9, wherein the DC power source is configured to supply a voltage of at least 48 V across the first DC power line conductor and the second DC power line conductor.

14. A method for filtering electromagnetic interference (EMI) in a power circuit comprising:
providing a core forming a closed magnetic circuit, the core having a first core pillar, a second core pillar and a third core pillar extending in a parallel direction, wherein the second core pillar is arranged between the first core pillar and the third core pillar,
ends of the first core pillar and the second core pillar are connected by first bridging legs, and ends of the second core pillar and the third core pillar are connected by second bridging legs,
the first core pillar, the second core pillar and the first bridging legs delimiting a first opening,
the second core pillar, the third core pillar and the second bridging legs delimiting a second opening,
providing a first coil around the first core pillar and/or the first bridging legs, the first coil is part of a first DC power line conductor for connection to a DC power source and a load,
providing a second coil around the third core pillar and/or the second bridging legs, the second coil is part of a second DC power line conductor for connection to a DC power source and a load,
providing a compensation circuit comprising a compensation winding, the compensation winding is arranged on the core and comprises a first compensation coil and a second compensation coil, the first compensation coil is arranged around the first core pillar and/or the first bridging legs, and the second compensation coil is arranged around the third core pillar and/or the second bridging legs,
controlling a compensation current in the compensation winding, so that a magnetic flux density in the second core pillar is generated in a direction opposing a magnetic flux density generated by the first coil and by the second coil.

15. The method according to claim 14, wherein the core is gapless, and forms a closed magnetic circuit out of material with uniform magnetic permeability, wherein the first coil is connected at one end to a first terminal of the DC power source, and the second coil, which is part of a DC power line conductor, is connected at one end to a second terminal of the DC power source.

16. The method according to claim 14, wherein the first compensation coil and the second compensation coil are connected in series.

17. The method according to claim 14, wherein the first compensation coil and the second compensation coil are connected in parallel.

18. The method of claim 14, wherein controlling the compensation current includes using an open loop compensation algorithm that provides the compensation current in the compensation winding dependent on a DC current in the first coil and/or the second coil.

19. The method of claim 14, wherein the first coil is connected at one end to a first terminal of the DC power source, and the second coil is connected at one end to a second terminal of the DC power source.

20. The method of claim 14, wherein providing the first coil includes providing a plurality of turns of a conductor having a rectangular cross section.
